(19) United States
(12) Patent Application Publication
(10) Pub. No.: US 2011/0123671 A1
(43) Pub. Date: May 26, 2011

(54) ADDITIVE FOR LIVESTOCK FEED AND FEED COMPOSITION FOR LIVESTOCK

(76) Inventors: Makoto Miura, Kawasaki-shi (JP); Kazuki Nakagawa, Tokyo (JP); Shigeyuki Takeuchi, Tokyo (JP); Kazumasa Watanabe, Tokyo (JP)

(21) Appl. No.: 13/021,083

(22) Filed: Feb. 4, 2011

Related U.S. Application Data
(63) Continuation of application No. PCT/JP2010/059878, filed on Jun. 10, 2010.

(30) Foreign Application Priority Data
Jun. 12, 2009 (JP) 2009-141105

(51) Int. Cl. A23K 1/18; A23K 1/00

(52) U.S. Cl. 426/2; 426/656

(57) ABSTRACT

The invention provides an additive for livestock feed and ingredients for a feed composition for livestock to improve the feed conversion ratio and the body weight gain efficiency by increasing the feed intake of livestock. The feed intake of livestock can be increased by providing the additive in the livestock feed, which includes monosodium L-glutamate and L-tryptophan, and wherein the mass ratio of free monosodium L-glutamate (provided that all converted into monosodium L-glutamate monohydrate) and free L-tryptophan (GLU/TRP ratio) is from 0.5 to 30.

This application is a continuation under 35 U.S.C. §120 of PCT Patent Application No. PCT/JP2010/059878, filed Jun. 10, 2010, which claims priority under 35 U.S.C. §119 to Japanese Patent Application No. 2009-141105, filed on Jun. 12, 2009, which are incorporated in their entireties by reference.

### BACKGROUND OF THE INVENTION

1. Field of the Invention

This invention relates to an additive for livestock feed, and its use in a feed composition for livestock to improve feed intake, feed conversion ratio, and body weight gain of livestock.

2. Brief Description of the Related Art

Mammalian livestock such as pigs are bred together with their dams by suckling for a certain period of time after their birth. During the weaning period, however, solid feed is given. During this weaning period, feed intake is sometimes reduced due to the stress caused by the environmental changes after weaning and the change of the feed type. In addition, it is known that dyspeptic and infectious diarrhea, or the infection itself, can cause reduced feed intake by livestock and can become a factor in growth retardation.

On the other hand, L-tryptophan is one of the amino acids which constitute body proteins and is regarded as an essential amino acid (indispensable amino acid), which means that it is necessary for animals to ingest it in their food because it cannot be synthesized in the animal body. Since L-tryptophan is a limiting amino acid after L-lysine and L-threonine, general feed formulations for livestock are designed to fully satisfy the L-tryptophan requirement of livestock by formulating L-tryptophan in order to accelerate the growth of livestock. This means, on the contrary, that when the supply of L-tryptophan from feed is limited, protein synthesis is stagnated and then growth is retarded. Actually, it has been reported that an aqueous solution of tryptophan obtained from a culture of a microorganism having the ability to produce L-tryptophan can be used as a feed composition (JP-A-61-212249). In this way, L-tryptophan is deeply related to the muscle protein synthesis. On the other hand, L-tryptophan is also involved in physiological functions, such as for the regulatory function of feed intake. L-tryptophan is a precursor of serotonin and melatonin which play a main role in controlling ingestion (Animal Feed Science and Technology, 132; 49-65 (2007) and Journal of Pineal Research, 21; 251-256 (1996)). Serotonin controls appetite and ingestion behavior mainly in the central nervous system, and melatonin controls them mainly in the peripheral nervous system. In addition, according to the recent studies, it has been shown that the L-tryptophan level in feed can influence the blood concentration of ghrelin, which is a hormone involving in the intake of nutrients, and the gene expression levels in gastric fundus and the duodenum (Domestic Animal Endocrinology, 33; 47-61 (2007)).

Therefore, it is clear that L-tryptophan is essential as one of the substrates for protein synthesis in the body, and also is greatly related to appetite regulation.

Also, monosodium L-glutamate is a substance which improves palatability and is used widely and industrially as an umami compound. Thus, it is widely available in the field of feed formulation (JP-A-2002-45122). Monosodium L-glutamate dissociates into L-glutamic acid and sodium when it is ingested, and it has been found from mice studies that there are specific receptors for L-glutamic acid (Nature Neuroscience, 3 (2); 113-119 (2000)). Also, it has been found from rat studies that gastric function is enhanced by stimulating an umami-responding neuron when L-glutamic acid binds to the receptor present in the oral cavity (Asia Pacific Journal of Clinical Nutrition, 17 (S1); 372-375 (2008)).

Furthermore, an L-glutamate receptor was also found in the rat stomach (FEBS Letters, 581; 1119-1123 (2007)), and it is possible that the signaling of information on digestion is delivered to the brain via the vagus nerve (Asia Pacific Journal of Clinical Nutrition, 17 (S1); 372-375 (2008)). It has been considered that this information delivered to the brain is related to the acceleration of gastric emptying in human, namely, the improvement of discomfort in stomach (Gastroenterology, 130 (Supple 2); A246 (2006)), and to the improvement of digestive functions, for example, enhancing gastric juice secretion, in dog and human (Voprosy Pitaniia, 3; 29-33 (1003) and Voprosy Pitaniia, 5 and 6; 19-22 (1992)).

In addition, a feed composition for cattle containing a) L-tryptophan, b) a sugar and c) a glycogenic amino acid or its salt at a ratio of a:b:c of 1-10:1-10:1-10 (weight ratio) has been disclosed, as well as a method which effectively improves the nutritional conditions during unstable periods of beef, dairy and breeding cattle. Additionally, glutamic acid is exemplified as a glycogenic amino acid (JP-A-2-273145).

### SUMMARY OF THE INVENTION

Although it is known that the efficiency of livestock to gain weight is increased to a certain degree by adding L-tryptophan as described above, there is a limitation in that excessive addition of L-tryptophan is not dose-dependent with increasing body weight. According to the feed composition for cattle described in JP-A-2-273145, it is expected that nutritional conditions of beef cattle during unstable periods can be improved by using L-tryptophan and a glycogenic amino acid, and that retardation of body weight gain can be also improved. However, only glycine and alanine were administered to cattle as the glycogenic amino acid, and the combination of L-tryptophan and glutamic acid has not been reported and therefore its effects are not clear.

Accordingly, aspects of the present invention include to provide an additive for livestock feed and a feed composition for livestock, both of which will improve the feed conversion ratio and body weight gain efficiency by further increasing the feed intake of livestock.

The present inventors have conducted various examinations and found as a result that the feed conversion ratio and body weight gain efficiency are improved when feed containing L-tryptophan and monosodium L-glutamate at a specific mass ratio is provided to livestock.

That is, the invention includes the following:

It is as aspect of the present invention to provide a feed additive for livestock, which comprises monosodium L-glutamate and L-tryptophan, wherein the mass ratio of free monosodium L-glutamate and free L-tryptophan (GLU/TRP ratio) is from 0.5 to 30.

It is another aspect of the present invention to provide a feed additive as described above, wherein the monosodium L-glutamate has been converted into monosodium L-glutamate monohydrate.

It is another aspect of the present invention to provide a feed additive for livestock as described above, wherein the GLU/TRP ratio is from 1.0 to 12.

It is another aspect of the present invention to provide a feed additive for livestock, which comprises L-glutamic acid and L-tryptophan, wherein the mass ratio of free L-glutamic acid and free L-tryptophan (GLU/TRP ratio) is 0.5 to 30.

It is another aspect of the present invention to provide a feed additive for livestock as described above, wherein the livestock is a non-ruminant animal.

It is another aspect of the present invention to provide a feed additive for livestock as described above, wherein the non-ruminant animal is a pig.

It is another aspect of the present invention to provide a feed composition for livestock, which comprises an amino acid selected from the group consisting of L-tryptophan, L-glutamic acid, monosodium L-glutamate L-lysine, and combinations thereof, and wherein the mass ratio of free monosodium L-glutamate and free L-trytophan is from 0.5 to 30, and the mass ratio of total L-tryptophan to L-lysine is larger than the ratio considered to be nutritionally optimum for livestock.

It is another aspect of the present invention to provide a feed composition as described above, wherein all of the monosodium L-glutamate has been converted into monosodium L-glutamate monohydrate.

It is another aspect of the present invention to provide a feed composition as described above, wherein the GLU/TRP ratio is from 1.0 to 12.

It is another aspect of the present invention to provide a feed composition for livestock, which comprises, an amino acid selected from the group consisting of L-tryptophan, L-glutamic acid, monosodium L-glutamate, L-lysine, and combinations thereof, and wherein the mass ratio of free L-glutamic acid and free L-trytophan is from 0.5 to 30, and the mass ratio of total L-tryptophan/L-lysine is larger than the ratio considered to be nutritionally optimum for livestock.

It is another aspect of the present invention to provide the feed composition as described above, wherein the livestock is a non-ruminant animal.

It is another aspect of the present invention to provide the feed composition as described above, wherein the non-ruminant is a pig.

It is another aspect of the present invention to provide a method for producing a feed composition for livestock, which comprises adding monosodium L-glutamate and L-tryptophan to a livestock feed so that the GLU/TRP ratio is from 0.5 to 30, and the mass ratio of total L-tryptophan to L-lysine is larger than the ratio considered to be nutritionally optimum for livestock.

It is another aspect of the present invention to provide a method for producing a feed composition comprising adding the feed additive as described above to livestock feed.

It is another aspect of the present invention to provide a method for feeding a livestock comprising providing the livestock with the feed additive or the feed composition described above.

It is another aspect of the present invention to provide a method for improving the feed conversion ratio and body weight gain efficiency of livestock, which comprises feeding the livestock with the feed additive or feed composition described above.

Furthermore, the invention relates to the use of the feed additive for livestock described above for producing a feed composition for livestock in order to improve feed conversion ratio and body weight gain efficiency of livestock. In addition, the invention also relates to the feed additive for livestock described above or the feed composition for livestock feed described above, for use in improving feed conversion ratio and body weight gain efficiency of livestock.

According to the invention, the feed conversion ratio and body weight gain efficiency of livestock can be improved by feeding the feed additive and the feed composition to livestock, via the synergistic effects of both increasing ingestion by L-tryptophan and improving the palatability and digestive function by monosodium L-glutamate or L-glutamic acid. As the result, effects such as improvement of productivity of livestock and economic efficiency can be obtained.

### DESCRIPTION OF THE PREFERRED EMBODIMENTS

Hereinafter, the substances, additives, and compositions embodying principles of the present invention are described. Also, a feed additive and feed compositions for livestock, a method for making the feed composition, a method of feeding the feed composition to livestock, and a method for increasing body weight gain of livestock are described in detail.

The term “livestock” can mean an industrial animal raised for milk, meat, or leather. Examples of livestock include, but are not limited to, cattle, pig, chicken, horse, turkey, sheep and goat.

Hereinafter, amino acids embodying principles of the present invention are described.

Free amino acids can mean amino acids in their free-form, and do not include amino acids which constitute proteins. Total amino acids can mean, or include, both free and amino acids which constitute proteins. The term “monosodium L-glutamate” can mean free monosodium L-glutamate. The term “L-glutamic acid” can mean free L-glutamic acid. The term “L-lysine” can mean total L-lysine. In addition, the term “L-tryptophan” can mean free or total L-tryptophan.

The amino acids embodying principles of the present invention can be either in hydrate or anhydride form.

The term “GLU/TRP ratio” can mean the mass ratio of free monosodium L-glutamate, provided that all of the free monosoldium L-glutamte is converted into monosodium L-glutamate monohydrate, and free L-tryptophan.

The terms “L-glutamic acid” and “monosodium L-glutamate” can mean that either L-glutamic acid or monosodium L-glutamate, or both, can be present at the same time. For example, Table 1 shows specific examples of an anhydride or hydrate of monosodium L-glutamate and L-glutamic acid which can be converted into monosodium L-glutamate monohydrate.

TABLE 1

| | | Converted | |
|---|---|---|---|
| | Description in | mass | Molecular |
| Item | examples | ratio | weight |
| Monosodium L-glutamate | Monosodium | 1.0 | 187.13 |
| monohydrate (%) | L-glutamate | | |
| Monosodium L-glutamate | — | 0.90 | 169.11 |
| anhydride (%) | | | |
| L-glutamic acid | — | 0.88 | 165.14 |
| monohydrate (%) | | | |
| L-glutamic acid | L-glutamic | 0.79 | 147.13 |
| anhydride (%) | acid | | |

The L-amino acids embodying principles of the present invention can be salts of the L-amino acids. L-lysine hydrochloride, L-lysine L-glutamate, and L-lysine L-aspartate are examples. The mass of the L-lysine salt can be converted to be equimolar to L-lysine.

Also, the amino acids embodying principles of the present invention can be in the L-isomer form for greater efficiency, but the D-isomer form can also be used.

The monosodium L-glutamate, L-glutamic acid, L-tryptophan and L-lysine can be produced by a synthesis method, an extraction method, or a fermentation method, but the method of production is not particularly limited.

Hereinafter, the methods for measuring the amounts of the amino acids are described for free amino acids, amino acids constituting proteins, and the total amino acids.

Regarding the free amino acids, pure water is added to the feed additive, then the concentration of amino acids in the aqueous solution is measured by an amino acid analyzer using the ninhydrin reaction (e.g., the L-8800 type or L-8900 type high speed amino acid analyzer manufactured by Hitachi High-Technologies Corporation, physiological fluid analysis), and finally, the amounts of the amino acids can be calculated from this measurement. The total amino acid can be determined by using an amino acid analyzer (e.g., the amino acid analyzer JLC-500/V, manufactured by JEOL, the standard method) in the same manner as the above free amino acid measuring method, after acidic hydrolysis of proteins. The amino acids constituting proteins can be calculated by subtracting the measured value of free amino acids from the measured value of the total amino acids. The glutamic acid detected by this measurement is calculated by converting it into monosodium glutamate. In addition, the amino acids can be measured solely by liquid chromatography, gas chromatography, or mass spectrometry, or any of these in combination.

The feed additive embodying principles of the present invention (also simply referred to as an “additive for feed”) is described.

The additive for feed can contain monosodium L-glutamate and L-tryptophan at a specific ratio in the final composition, also referred to as the GLU/TRP ratio.

The GLU/TRP ratio in the additive for feed can be from 0.5 to 30, 0.5 to 20, 0.5 to 15, 0.5 to 14, 1.0 to 12, 1.0 to 11, 1.0 to 10, 5.0 to 10, or even from 7.0 to 10. The effect of the invention is shown when the GLU/TRP ratio in the additive for feed is 0.5 or more, and the cost of the additive for feed can be reduced when the GLU/TRP ratio is 30 or less.

Hereinafter, the feed composition for livestock embodying principles of the present invention (also simply referred to as “feed composition”) is described.

The feed composition of the invention is a composition to which the above additive for feed is added.

The feed composition includes one or more amino acids, such as L-tryptophan, L-glutamic acid, monosodium L-glutamate and L-lysine, wherein the GLU/TRP ratio can be within a specified range and the mass ratio of total L-tryptophan to L-lysine is larger than the ratio considered to be nutritionally optimum for livestock.

The GLU/TRP ratio in the feed composition can be from 0.5 to 30, 0.5 to 20, 0.5 to 15, 0.5 to 14, 1.0 to 12, 1.0 to 11, 1.0 to 10, 5.0 to 10, or even from 7.0 to 10. The effect of the invention is shown when the GLU/TRP ratio in the feed composition is 0.5 or more, and the cost of the feed composition can be reduced when the GLU/TRP ratio is 30 or less.

Also, the methods for measuring free amino acids, amino acids constituting proteins, and total amino acids are similar to the methods for the above additive for feed.

L-lysine, which is an essential amino acid like L-tryptophan, is provided for feed compositions, and is present in general feed materials. In a practical feed, L-lysine tends to restrict the availability of the other essential amino acids. Therefore L-lysine is also known as the first limiting amino acid, and the requirements of essential amino acids for livestock are sometimes shown as an ideal amino acid profile using L-lysine as a reference. As an embodiment of the invention, the mass ratio of total L-tryptophan/L-lysine in the feed composition can be adjusted so that it is larger than the ratio considered to be nutritionally optimum for livestock. That is, in order to show the effect of the invention sufficiently, the total L-tryptophan to L-lysine ratio in the feed composition can be adjusted so that it is larger than the mass ratio calculated from the recommended amounts in the general air-dried feed, based on the ideal profile of essential amino acids. It is considered that the mass ratio of total L-tryptophan to L-lysine in the feed composition is, for example, 0.19 or more for piglets, and growing and adult pigs, 0.16 or more for pregnant sows and 0.19 or more for lactating sows (Japanese Feeding Standard for Swine (2005), Japan Livestock Industry Association, p. 113); in the case of poultry (Japanese Feeding Standard for Poultry (2004), Japan Livestock Industry Association, p. 14-15), it is 0.20 or more at the growing period of egg-type chickens, 0.26 or more at the laying period of egg-type chickens, and 0.18 or more for broilers. It is 0.21 or more and 0.23 or more for Japanese quail and ducks, respectively (Japanese Feeding Standard for Poultry (2004), Japan Livestock Industry Association, p. 18-19). When L-lysine and L-tryptophan are present in the feed composition in amounts so that the ratio is larger than considered to be nutritionally optimum for each livestock species, proteins are efficiently synthesized because the demand for L-lysine by the livestock is satisfied, and at the same time, the feed conversion ratio and body weight gain efficiency can be improved by increasing the feed intake due to acceleration of ingestion caused by the L-tryptophan. However, it is known that, when the mass ratio is higher, it is hard to obtain dose-dependent improvement of the feed conversion ratio and body weight gain efficiency which are expected by an additional amount of L-tryptophan. The method embodying principles of the present invention improves the feed conversion ratio and body weight gain efficiency when an additional amount of L-tryptophan is added, and where this dose-dependent improvement could not be previously obtained.

When the mass ratio of total L-tryptophan to L-lysine is larger than the mass ratio nutritionally required by livestock, the mass ratio of total L-tryptophan to L-lysine can be larger than 0.15, larger than 0.19, larger than 0.20, larger than 0.21, larger than 0.22, or even larger than 0.24.

Also, the additive for feed can be provided as a feed composition when it is combined with a general feed. So long as the general feed does not impair the effect of the additive, it is not particularly limited and can include mother's milk, a milk replacer, a pre-initial stage feed (a pre-starter feed), an initial stage feed (a starter feed), a growing and finishing stage feed, and the like.

The feed composition of the invention can be used by mixing with at least one of the “feed materials” defined below, so long as it does not influence the effect of the methods described herein. The “feed materials” can include, for example, brans, such as wheat bran, rice bran, barley bran, and millet bran; food processing by-products, such as soybean-curd residue, starch pulp, copra meal, sake cake, soy sauce cake, brewer's grains, sweet potato distiller's residue, and juice pulp of fruits and vegetables; cereals, such as corn, rice, wheat, barley, and oat; oil seed meals, such as soybean meal, rapeseed meal, cotton seed meal, linseed meal, sesame meal, and sunflower meal; animal origin feeds, such as fish meal, casein, dried skim milk, dried whey, meat and bone meal, meat meal, feather meal, and blood meal; leaf meals, such as alfalfa meal; and the like.

A filler, an extender, a nutrition reinforcing agent, a feed additive and the like can also be blended in the additive for feed and/or the feed composition, so long as they do not impair the effect of the methods described herein. As the filler, for example, cellulose derivatives such as carboxymethylcellulose can be mentioned; as the extender, for example, dextrin, starch and the like can be mentioned; as the nutrition reinforcing agent, for example, vitamins and minerals can be mentioned; and as the feed additive, for example, enzyme preparations, probiotics and the like can be mentioned.

The additive for feed can be given to livestock by itself, but it can also be given after mixing it with a general feed. In the case of raising a pig, for example, only mother's milk is provided just after birth, but 1 to 2 weeks thereafter, a pre-initial stage feed (pre-starter feed) is provided together with the mother's milk. This is then changed to an initial stage feed (starter feed) as the weaning starts, and fattening is carried out thereafter using a growing and finishing stage feed. In addition, in the case of ruminants such as cattle, sheep and goat, mother's milk or a milk replacer is provided together with a solid feed until the rumen is formed and then completely changed to a solid feed simultaneously with the weaning. The additive for feed of the invention can improve the feed conversion ratio and body weight gain efficiency when added to any of these feeds.

Also, the additive for feed and the feed composition can be given generally to all livestock, but can exert a superior effect on non-ruminants. For example, feed conversion ratio and body weight gain can be significantly improved for non-ruminants, such as pig, chicken, horse, rabbit, duck, turkey, Japanese quail and ostrich, and the effect can be fully obtained, particularly for pig.

Also, the method of adding the additive to feed or a feed composition is not particularly limited, so long as the GLU/TRP ratio in the feed composition is within the aforementioned range and the mass ratio of total L-tryptophan/L-lysine is larger than the aforementioned mass ratio. For example, the feed additive can be added as a powder, a solid, or a liquid.

The feed composition prepared in this manner can be given to livestock by a general feeding method. In addition, the livestock provided with the feed composition can efficiently accelerate their body weight gain. It is considered that this is based on the acceleration of the ingestion by L-tryptophan, and the further increase of feed intake by the improvement of palatability and digestive functions by monosodium L-glutamate or L-glutamic acid. Also, as the general fattening method, a feed which sufficiently satisfies the nutritional requirements for each kind and growth stage of livestock can also be continuously provided.

The method for increasing body weight gain of livestock is a method which improves feed conversion ratio and body weight gain efficiency of livestock when the feed composition described herein is given to livestock without restricting the period. Alternatively, a method is also provided which improves the feed conversion ratio and body weight gain efficiency of livestock when the feed composition described herein is given to livestock within a certain period.

Thus, the method for improving feed conversion ratio and body weight gain efficiency obtained by providing livestock with the additive for feed and the feed composition described herein can be industrially useful when provided to livestock under stressful environments such as after changing to a different feed, at weaning period, or in housing under high density conditions.

The invention is specifically described based on the examples, but the invention is not limited to the examples. Also, unless otherwise indicated, the term “%” means “% by weight”.

In addition, monosodium L-glutamate monohydrate is used as monosodium L-glutamate in the examples, and L-glutamic acid anhydride is used as the L-glutamic acid, but as described above, each of their anhydride or hydrate can also be used at an equimolar level.

### EXAMPLES

Example 1

The effect of total L-tryptophan in feed and the effect of adding monosodium L-glutamate to the feed which contains a sufficient amount of total L-tryptophan was examined. A total of 216 weaned and castrated male piglets (Landrace×Large White×Duroc, crossbred) were randomly allocated to six treatments with six replications using six piglets in each pen as an experimental unit in a complete block design. Comparative feed 1 to 4 (Comparative Examples) and inventive feed 1 and 2 (Examples) containing the amino acids shown in Table 2 were given to each treatment group.

Comparative Example 1 was formulated as shown in Table 3. This formulation contained 1.29% of L-lysine without the addition of monosodium L-glutamate. For Comparative Examples 2 to 4 and Examples 1 and 2, the formulation of Comparative Example 1 was used as the basal composition and each amino acid was added by substitution for corn starch shown in Table 3. In Examples 1 and 2, formulations were designed so that the amount of monosodium L-glutamate added is 5 and 10 times that of the added L-tryptophan as compared to the formulation of Comparative Example 4, respectively. In the formulations of Comparative Examples 1 and 2, only L-tryptophan was added, so that the mass ratio of total L-tryptophan to L-lysine was lower than the ratio considered to be nutritionally optimum for piglets (0.19), while it was higher than the optimum ratio in Comparative Examples 3 and 4 and Examples 1 and 2.

Weaning piglets were fed these diets ad libitum for 28 days. By measuring body weight and the residual feed at the start and 28 days after the administration, feed intake, body weight gain (increased amount of body weight) and feed conversion ratio were calculated. The results are shown in Table 4.

TABLE 2
Table 2: Added amount of amino acid in test feed

| | Comp. | Comp. | Comp. | Comp. | Exam- | Exam- |
|---|---|---|---|---|---|---|
| Amino acids | Ex. 1 | Ex. 2 | Ex. 3 | Ex. 4 | ple 1 | ple 2 |
| L-tryptophan | 0.00 | 0.04 | 0.08 | 0.11 | 0.11 | 0.11 |
| Monosodium | 0.00 | 0.00 | 0.00 | 0.00 | 0.56 | 1.13 |
| L-glutamate | | | | | | |

(% in feed)

TABLE 3
Formulation composition of Comp. Ex. 1 diet

| Materials | Formulation ratio (%) |
|---|---|
| Corn | 70 |
| Soybean meal | 24 |
| Corn starch | 2 |
| Fat | 2 |
| Others | 3 |
| Total | 100 |

TABLE 4
Test results

| | Comp. | Comp. | Comp. | Comp. | Exam- | Exam- |
|---|---|---|---|---|---|---|
| Items | Ex. 1 | Ex. 2 | Ex. 3 | Ex. 4 | ple 1 | ple 2 |
| Amount of L-tryptophan | 0 | 0.04 | 0.08 | 0.11 | 0.11 | 0.11 |
| added (%) (A) | | | | | | |
| Amount of monosodium | 0 | 0 | 0 | 0 | 0.56 | 1.13 |
| L-glutamate added (%) (B) | | | | | | |
| Ratio of amino acids | — | — | — | — | 5 | 10 |
| added (B/A) | | | | | | |
| Total L-tryptophan/L- | 0.15 | 0.18 | 0.20 | 0.23 | 0.22 | 0.24 |
| lysine mass ratio in feed | | | | | | |
| Average body weight | 11.39 | 11.39 | 11.39 | 11.39 | 11.39 | 11.39 |
| when started (kg) | | | | | | |
| Average body weight | 21.74^{a} | 22.62^{ab} | 22.03^{a} | 22.78^{abc} | 23.26^{bc} | 23.69^{c} |
| when finished (kg) | | | | | | |
| Feed intake (kg/day) (C) | 0.722 | 0.758 | 0.725 | 0.769 | 0.786 | 0.804 |
| Weight gain (kg/day) (D) | 0.370^{a} | 0.401^{abc} | 0.380^{ab} | 0.407^{bcd} | 0.424^{cd} | 0.439^{d} |
| Feed conversion ratio (C/D) | 1.956^{a} | 1.892^{abc} | 1.909^{ab} | 1.894^{abc} | 1.855^{bc} | 1.830^{c} |

^{a},^{b},^{c},^{d}Values with unlike signs have statistical difference (p < 0.05).

The results of Comparative Examples 1 to 4 are shown in Table 4. As can be seen, the average body weight, which was equal among the groups at the beginning of the test, tended to increase concomitant with satisfying the requirement of total L-tryptophan in the feed by the addition of L-tryptophan. The results of Comparative Examples 2 to 4 show that the final body weight reached a plateau when the total amount of L-tryptophan met its requirement. As compared to Comparative Example 4, the final body weight in both Examples 1 and 2 tended to increase again by the combination with monosodium L-glutamate. Also, a similar tendency was observed in body weight gain, feed intake, and feed conversion ratio (feed amount required for increasing 1 kg of body weight gain).

Based on the above results, the addition of both L-tryptophan and monosodium L-glutamate to the feed resulted in the feed intake of the weaning piglets to increase, and improvements in the feed conversion ratio and the acceleration of growth were found. In addition, the combined use of L-tryptophan and monosodium L-glutamate was more effective than when L-tryptophan was used alone.

Example 2

The effect of adding monosodium L-glutamate alone to the feed was examined. A total of 216 weaned and castrated male piglets (Landrace×Large White×Duroc, crossbred) were randomly allocated to six treatments with six replications using six piglets in each pen as an experimental unit in a complete block design. Comparative Examples 5 to 8 and Examples 3 and 4 containing the amino acids shown in Table 5 were given to each treatment group.

Comparative Example 5 was formulated as shown in Table 6. This formulation represents a feed composition used commercially, and contains 1.27% of L-lysine without the addition of monosodium L-glutamate. For Comparative Examples 6 to 8 and Examples 3 and 4, the formulation of Comparative Example 5 was used as the basal composition and each amino acid was added by substitution for corn starch shown in Table 6. Only monosodium L-glutamate alone was added to the formulations in Comparative Examples 6 and 7, and they were compared at a ratio lower than the ratio considered nutritionally optimum for piglets (0.19). In Comparative Example 8, 0.11% of L-tryptophan was added to the formulation of Comparative Example 5. In Examples 3 and 4, formulations were designed so that the amount of monosodium L-glutamate added was equivalent to, and 10 times that of the added L-tryptophan in the formulation of Comparative Example 8, respectively. In the formulations of Comparative Examples 8 and Examples 3 and 4, L-tryptophan was added so that the mass ratio of total L-tryptophan to L-lysine was higher than the ratio considered nutritionally optimum for piglets (0.19).

Weaning piglets were fed these diets ad libitum for 28 days. By measuring body weight and the residual feed at the start and 28 days after the administration, feed intake, body weight gain and feed conversion ratio were calculated. The results are shown in Table 7.

TABLE 5
Table 5: Added amount of amino acid in test feed

| | Comp. | Comp. | Comp. | Comp. | Exam- | Exam- |
|---|---|---|---|---|---|---|
| Amino acids | Ex. 5 | Ex. 6 | Ex. 7 | Ex. 8 | ple 3 | ple 4 |
| L-tryptophan | 0.00 | 0.00 | 0.00 | 0.11 | 0.11 | 0.11 |
| Monosodium | 0.00 | 0.11 | 1.13 | 0.00 | 0.11 | 1.13 |
| L-glutamate | | | | | | |

(% in feed)

TABLE 6
Formulation composition of Comp. Ex. 5 diet

| Materials | Formulation ratio (%) |
|---|---|
| Corn | 65 |
| Soybean meal | 24 |
| Corn starch | 2 |
| Fat | 4 |
| Others | 6 |
| Total | 100 |

TABLE 7
Table 7: Test results

| | Comp. | Comp. | Comp. | Comp. | Exam- | Exam- |
|---|---|---|---|---|---|---|
| Items | Ex. 5 | Ex. 6 | Ex. 7 | Ex. 8 | ple 3 | ple 4 |
| Amount of L-tryptophan | 0 | 0 | 0 | 0.11 | 0.11 | 0.11 |
| added (%) (A) | | | | | | |
| Amount of monosodium | 0 | 0.11 | 1.13 | 0 | 0.11 | 1.13 |
| L-glutamate added (%) (B) | | | | | | |
| Ratio of amino acids | — | — | — | — | 1 | 10 |
| added (B/A) | | | | | | |
| Total L-tryptophan/L- | 0.14 | 0.14 | 0.14 | 0.22 | 0.21 | 0.22 |
| lysine mass ratio in feed | | | | | | |
| Average body weight | 10.08 | 10.08 | 10.08 | 10.08 | 10.08 | 10.08 |
| when started (kg) | | | | | | |
| Average body weight | 21.15 | 21.69 | 22.08 | 21.16 | 22.76 | 22.71 |
| when finished (kg) | | | | | | |
| Feed intake (kg/day) (C) | 0.693 | 0.717 | 0.716 | 0.667 | 0.758 | 0.723 |
| Weight gain (kg/day) (D) | 0.395 | 0.415 | 0.429 | 0.396 | 0.453 | 0.451 |
| Feed conversion ratio (C/D) | 1.760^{a} | 1.731^{ab} | 1.670^{b} | 1.686^{b} | 1.675^{b} | 1.603^{c} |

^{a},^{b},^{c},^{d}Values with unlike signs have a statistical difference (p < 0.05).

When monosodium L-glutamate was used in combination (Examples 3 and 4) with L-tryptophan at a level which satisfied the requirement in the feed (Comparative Example 8), body weight gain and feed intake were increased concomitant with the increasing of monosodium L-glutamate in the feed, and the improvement of feed conversion ratio was statistically significant. In addition, the body weight gain, feed intake, and feed conversion ratio shown for the piglets in Examples 3 or 4, in which L-tryptophan and monosodium L-glutamate were used in combination, were increased in comparison with those shown in the piglets in Comparative Examples 6 or 7, which were given only monosodium L-glutamate alone.

Based on the above results, the combined use of monosodium L-glutamate and L-tryptophan was more effective than using monosodium L-glutamate alone, for body weight gain, feed intake and feed conversion ratio of the weaning piglets.

### Example 3

Under the same conditions of Example 1, the effect of L-glutamic acid on body weight gain, feed intake and feed conversion ratio of weaning piglets was examined. L-glutamic acid is the form of monosodium L-glutamate which exists in the digestive tracts and oral cavity. A total of 216 weaned and castrated male piglets (Landrace×Large White×Duroc, crossbred) were randomly allocated to six treatments with six replications using six piglets in each pen as an experimental unit in a complete block design. Feed compositions shown in Comparative Examples 9 to 12 and Examples 5 and 6 containing the amino acids shown in Table 8 were given to each treatment group.

Comparative Example 9 was formulated as shown in Table 9. This formulation is a feed composition used commercially, and contains 1.31% of L-lysine without the addition of monosodium L-glutamate. For Comparative Examples 10 to 12 and Examples 5 and 6, the formulation of Comparative Example 9 was used as the basal composition and each amino acid was added by substitution for corn starch shown in Table 9. The formulations of Comparative Examples 10 to 12 were prepared by the addition of L-tryptophan alone step by step to the formulation of Comparative Example 9. Also, in Comparative Examples 9 and 10, the ratio of total L-tryptophan to L-lysine in each feed was lower than the ratio nutritionally required by piglets (0.19). It was higher than the mass ratio nutritionally required by piglets (0.19) in Comparative Example 12.

In Examples 5 and 6, formulations were designed in such a manner that the amount of added L-glutamic acid, which was converted into monosodium L-glutamate monohydrate, was 5 and 10 times that of L-tryptophan, and was added to the formulation of Comparative Example 12. Also, in Examples 5 and 6, the mass ratio of total L-tryptophan/L-lysine in the feed was higher than the mass ratio nutritionally required by piglets (0.19).

Weaning piglets were fed these diets ad libitum for 28 days. By measuring body weight and the residual feed at the start and 28 days after the administration, feed intake, body weight gain and feed conversion ratio were calculated. The results are shown in Table 10.

TABLE 8
Table 8: Added amount of amino acid in test feed

| | Comp. | Comp. | Comp. | Comp. | Exam- | Exam- |
|---|---|---|---|---|---|---|
| Amino acids | Ex. 9 | Ex. 10 | Ex. 11 | Ex. 12 | ple 5 | ple 6 |
| L-tryptophan | 0.00 | 0.04 | 0.08 | 0.11 | 0.11 | 0.11 |
| L-glutamic acid | 0.00 | 0.00 | 0.00 | 0.00 | 0.45 | 0.90 |

(% in feed)

TABLE 9
Formulation composition of Comp. Ex. 9 diet

| Materials | Formulation ratio (%) |
|---|---|
| Corn | 65 |
| Soybean meal | 24 |
| Corn starch | 1 |
| Fat | 4 |
| Others | 6 |
| Total | 100 |

TABLE 10
Table 10: Test results

| | Comp. | Comp. | Comp. | Comp. | Exam- | Exam- |
|---|---|---|---|---|---|---|
| Items | Ex. 9 | Ex. 10 | Ex. 11 | Ex. 12 | ple 5 | ple 6 |
| Amount of L-tryptophan | 0 | 0.04 | 0.08 | 0.11 | 0.11 | 0.11 |
| added (%) (A) | | | | | | |
| Amount of L-glutamic | 0 | 0 | 0 | 0 | 0.45 | 0.90 |
| acid added (%) | | | | | | |
| Amount as of monosodium | — | — | — | — | 0.56 | 1.13 |
| L-glutamate (%) (B) | | | | | | |
| Ratio of amino acids | | | | | 5 | 10 |
| added (B/A) | | | | | | |
| Total L-tryptophan/L- | 0.14 | 0.17 | 0.19 | 0.22 | 0.22 | 0.22 |
| lysine mass ratio in feed | | | | | | |
| Average body weight | 10.13 | 10.13 | 10.13 | 10.13 | 10.13 | 10.13 |
| when started (kg) | | | | | | |
| Average body weight | 19.87^{a} | 20.66^{b} | 21.52^{c} | 20.73^{b} | 21.98^{c} | 21.75^{c} |
| when finished (kg) | | | | | | |
| Feed intake (kg/day) (C) | 0.596^{a} | 0.623^{ab} | 0.665^{bc} | 0.610^{a} | 0.677^{c} | 0.654^{bc} |
| Weight gain (kg/day) (D) | 0.348^{a} | 0.376^{b} | 0.407^{c} | 0.379^{b} | 0.423^{c} | 0.415^{c} |
| Feed conversion ratio (C/D) | 1.716^{a} | 1.658^{ab} | 1.635^{bc} | 1.612^{bc} | 1.598^{bc} | 1.575^{c} |

^{a},^{b},^{c},^{d}Values with unlike signs have a statistical difference (p < 0.05).

Similar to the results in Comparative Examples 9 to 12, the average body weight, which was equal among the groups at the beginning of the test, tended to increase concomitant with satisfying the requirement of total L-tryptophan in the feed by the addition of L-tryptophan. And the results of Comparative Examples 11 and 12 show that the final body weight reached a plateau when the total amount of L-tryptophan met its requirement. And as can be seen from Examples 5 and 6, final body weight tended to further increase by the addition of L-glutamic acid. Also, a tendency towards improvement by the combined use of L-glutamic acid was shown for body weight gain, feed intake, and feed conversion ratio during the test.

Based on the above results, the addition of both L-tryptophan and L-glutamic acid to the feed resulted in an increase of the feed intake of the weaning piglets, and also improvement in the feed conversion ratio and weight gain efficiency were found. In addition, the combined use of L-tryptophan and L-glutamic acid was more effective than L-tryptophan was used alone.

### Example 4

The effect of monosodium L-glutamate in combination with L-tryptophan was examined. These ingredients were contained in a feed in a sufficient amount for their requirements for a piglet by using a feed composition used commercially, in which other feed materials were used in addition to corn and soybean meal. A total of 216 weaned and castrated male piglets (Landrace×Large White×Duroc, crossbred) were randomly allocated to six treatments with six replications using six piglets in each pen as an experimental unit in a complete block design. Feed compositions shown in Comparative Examples 13 and 14 and Examples 7 to 10 containing the amino acids shown in Table 11 were given to each treatment group.

Comparative Example 13 was formulated as shown in Table 12. This formulation is used commercially, and contains 1.27% of L-lysine without the addition of monosodium L-glutamate.

For Comparative Example 14 and Examples 7 to 10, the formulation of Comparative Example 13 was used as the basal composition and each amino acid was added by substitution of corn starch as shown in Table 12. In Comparative Example 13, the mass ratio of total L-tryptophan to L-lysine is lower than what is nutritionally required by piglets (0.19). But the formulation of Comparative Example 14 was designed so that the mass ratio (0.23) was obtained by adding L-tryptophan alone to satisfy its requirement. In Examples 7 to 10, the formulations were designed so that the amount of monosodium L-glutamate added is equivalent to, or 5, 7.5, or 10 times larger than the amount of L-tryptophan added to the formulation of Comparative Example 14, and the mass ratio of total L-tryptophan/L-lysine was higher than the mass ratio nutritionally required by piglets (0.19).

Weaning piglets were fed these diets ad libitum for 28 days. By measuring body weight and the residual feed at the start and 28 days after the administration, feed intake, body weight gain and feed conversion ratio were calculated. The results are shown in Table 13.

TABLE 11
Table 11: Added amount of amino acid in test feed

| | Comp. | Comp. | | | | |
|---|---|---|---|---|---|---|
| Amino acids | Ex. 13 | Ex. 14 | Ex. 7 | Ex. 8 | Ex. 9 | Ex. 10 |
| L-tryptophan | 0.00 | 0.10 | 0.10 | 0.10 | 0.10 | 0.10 |
| Monosodium | 0.00 | 0.00 | 0.10 | 0.50 | 0.75 | 1.00 |
| L-glutamate | | | | | | |

(% in feed)

TABLE 12
Formulation composition of Comp. Ex. 13 diet

| Materials | Formulation ratio (%) |
|---|---|
| Corn | 36 |
| Full fat soybean | 20 |
| Broken rice | 17 |
| Soybean meal | 8 |
| Cassava | 5 |
| Fish meal | 5 |
| Fat | 3 |
| Rice bran fullfat | 2 |
| Corn starch | 1 |
| Others | 3 |
| Total | 100 |

TABLE 13
Table 13: Test results

| | Comp. | Comp. | Exam- | Exam- | Exam- | Exam- |
|---|---|---|---|---|---|---|
| Items | Ex. 13 | Ex. 14 | ple 7 | ple 8 | ple 9 | ple 10 |
| Amount of L-tryptophan | 0.00 | 0.10 | 0.10 | 0.10 | 0.10 | 0.10 |
| added (%) (A) | | | | | | |
| Amount of monosodium | 0.00 | 0.00 | 0.10 | 0.50 | 0.75 | 1.00 |
| L-glutamate added (%) (B) | | | | | | |
| Ratio of amino acids | — | — | 1 | 5 | 7.5 | 10 |
| added (B/A) | | | | | | |
| Total L-tryptophan/L- | 0.17 | 0.23 | 0.23 | 0.23 | 0.23 | 0.24 |
| lysine mass ratio in feed | | | | | | |
| Average body weight | 9.97 | 9.97 | 9.97 | 9.97 | 9.97 | 9.97 |
| when started (kg) | | | | | | |
| Average body weight | 21.75 | 22.28 | 22.65 | 22.51 | 22.78 | 23.11 |
| when finished (kg) | | | | | | |
| Feed intake (kg/day) (C) | 0.656 | 0.661 | 0.677 | 0.659 | 0.665 | 0.677 |
| Weight gain (kg/day) (D) | 0.421 | 0.439 | 0.453 | 0.448 | 0.458 | 0.469 |
| Feed conversion ratio (C/D) | 1.561^{a} | 1.505^{b} | 1.494^{b} | 1.472^{bc} | 1.454^{c} | 1.444^{c} |

^{a},^{b},^{c},^{d}Values with unlike signs have a statistical difference (p < 0.05).

Similar to the results of Comparative Example 13 and 14, the average body weight, which was equal at the beginning of the test, tended to increase concomitant with satisfying the requirement of total L-tryptophan in the feed by the addition of L-tryptophan. In addition, as can be seen from Examples 7 to 10, it was found that the feed conversion ratio and body weight gain efficiency were increased when the amount of monosodium L-glutamate added was increased.

Based on the above results, it was found that feed intake of the weaning piglets was increased and that improvements in the feed conversion ratio and body weight gain efficiency were obtained by providing a feed composition for practical use on a commercial farm, in which the amount of total L-tryptophan satisfied the requirement of piglets, the mass ratio of total L-tryptophan/L-lysine was equal to or higher than the ratio considered to be nutritionally optimum, and monosodium L-glutamate was present.

### INDUSTRIAL APPLICABILITY

The feed composition and the livestock feed to which the feed composition is added improve the feed intake of livestock and improve body weight gain efficiency and feed conversion ratio.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A feed additive for livestock, which comprises monosodium L-glutamate and L-tryptophan, wherein the mass ratio of free monosodium L-glutamate and free L-tryptophan (GLU/TRP ratio) is from 0.5 to 30.

2. The feed additive of claim 1, wherein the monosodium L-glutamate has been converted into monosodium L-glutamate monohydrate.

3. The feed additive for livestock according to claim 1, wherein the GLU/TRP ratio is from 1.0 to 12.

4. A feed additive for livestock, which comprises L-glutamic acid and L-tryptophan, wherein the mass ratio of free L-glutamic acid and free L-tryptophan (GLU/TRP ratio) is from 0.5 to 30.

5. The feed additive for livestock according to claim 1, wherein the livestock is a non-ruminant animal.

6. The feed additive for livestock according to claim 5, wherein the non-ruminant animal is a pig.

7. The feed additive of claim 4, wherein the livestock is a non-ruminant animal.

8. The feed additive of claim 7, wherein the non-ruminant animal is a pig.

9. A feed composition for livestock, which comprises an amino acid selected from the group consisting of L-tryptophan, L-glutamic acid, monosodium L-glutamate, and L-lysine, and combinations thereof, and wherein the mass ratio of free monosodium L-glutamate and free L-tryptophan (GLU/TRP ratio) is from 0.5 to 30, and the mass ratio of total L-tryptophan/L-lysine is larger than the ratio considered to be nutritionally optimum for livestock.

10. The feed composition of claim 9, wherein the monosodium L-glutamate has been converted into monosodium L-glutamate monohydrate.

11. The feed composition for livestock according to claim 9, wherein the GLU/TRP ratio is from 1.0 to 12.

12. A feed composition for livestock, which comprises an amino acid selected from the group consisting of L-tryptophan, L-glutamic acid, monosodium L-glutamate, L-lysine, and combinations thereof, and wherein the mass ratio of free L-glutamic acid and free L-tryptophan (GLU/TRP ratio) is from 0.5 to 30, and the mass ratio of total L-tryptophan/L-lysine is larger than the ratio considered to be nutritionally optimum for livestock.

13. The feed composition for livestock according to claim 9, wherein the livestock is a non-ruminant animal.

14. The feed composition for livestock according to claim 13, wherein the non-ruminant animal is a pig.

15. The feed composition of claim 12, wherein the livestock is a non-ruminant animal.

16. The feed additive of claim 15, wherein the non-ruminant is a pig.

17. A method for producing a feed composition for livestock, which comprises adding monosodium L-glutamate and L-tryptophan to a livestock feed so that the GLU/TRP ratio is from 0.5 to 30, and the mass ratio of total L-tryptophan/L-lysine is larger than the ratio considered to be nutritionally optimum for livestock.

18. A method for producing a feed composition for livestock, comprising adding the feed additive described in claim 1 to livestock feed.

19. A method for feeding a livestock comprising providing the livestock with the feed additive described in claim 1.

20. A method for feeding a livestock comprising providing the livestock with the feed composition described in claim 9.

21. A method for improving the feed conversion ratio and body weight gain efficiency of livestock, which comprises feeding the livestock with the feed additive for livestock described in claim 1.

22. A method for improving the feed conversion ratio and body weight gain efficiency of livestock, which comprises feeding the livestock with the feed composition described in claim 9.
